(19) United States
(12) Patent Application Publication
(10) Pub. No.: US 2026/0101206 A1
(43) Pub. Date: Apr. 9, 2026

(54) OPEN RADIO ALTERNATE M-PLANE ADAPTATION METHOD AND PROCEDURE

(71) Applicants: AT&T Intellectual Property I, L.P., Atlanta, GA (US); AT&T Mobility II LLC, Atlanta, GA (US)

(72) Inventors: Thomas W. Henderson, Alpharetta, GA (US); Hardeep Singh, Johns Creek, GA (US); Brian Gavin, Sammamish, WA (US)

(73) Assignees: AT&T Intellectual Property I, L.P., Atlanta, GA (US); AT&T Mobility II LLC, Atlanta, GA (US)

(21) Appl. No.: 18/908,967

(22) Filed: Oct. 8, 2024

(51) Int. Cl. H04W 24/08

(52) U.S. Cl. CPC H04W 24/08

(57) ABSTRACT

Aspects of the subject disclosure may include, for example, communicating management plane (M-plane) data at a first port of a radio unit (RU), the RU being one RU of a set of radio units (RUs) at a cell site of a network operator, the M-plane data related to management and control of the RU, wherein the communicating M-plane data comprises communicating the M-plane data with a distributed unit (DU) over an M-plane segment, and initiating communication of the M-plane data at a second port of the RU, the second port configured for data communication over an alternate M-plane segment to a second RU of the set of RUs for forwarding the M-plane data to the DU over a second M-plane segment between the second RU and the DU, wherein the initiating communication is in response to an interruption in the communicating M-plane data.

Other embodiments are disclosed.

### FIELD OF THE DISCLOSURE

The subject disclosure relates to an alternate M-plane adaptation method and procedure for Open Radio Access Network equipment.

### BACKGROUND

Open Radio Access Network equipment includes separate components performing discrete functions. Such components include a Radio Unit (RU), a Distributed Unit (DU) and a Centralized Unit (CU). Interconnection among these components is standardized for interoperability among manufacturers'equipment.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating a conventional Open Radio Access Network.

FIG. 2B is a block diagram illustrating an example, non-limiting embodiment of a system functioning within the communication network of FIG. 1 in accordance with various aspects described herein.

FIG. 2C is a block diagram illustrating an example, non-limiting embodiment of a system functioning within the communications network 125 of FIG. 1 in accordance with various aspects described herein.

FIG. 2D depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a dedicated failover mechanism for the M-plane (Management Plane) in O-RU (Open Radio Unit) as part of the O-RAN (Open Radio Access Network) architecture. This includes method and apparatus for establishing a secondary physical interface and protocol specifically for maintaining M-plane operations in the event of a failure. Other embodiments are described in the subject disclosure.

One or more aspects of the subject disclosure include an Open Radio Access Network (O-RAN) Radio Unit (RU), comprising a first port configured for data communication, a second port configured for data communication with another O-RAN RU operating in an O-RAN, and a processing system for performing operations including communicating management plane (M-plane) data on the first port over an M-plane segment with a distributed unit (DU) operating in the O-RAN, detecting a failover condition of the M-plane segment, and automatically selecting the second port for communication of the M-plane data with the DU, wherein the automatically selecting the second port is responsive to the detecting the failover condition of the M-plane segment.

One or more aspects of the subject disclosure include communicating management plane (M-plane) data at a first port of a radio unit (RU), the RU being one RU of a set of radio units (RUs) at a cell site of a network operator, the M-plane data related to management and control of the RU, wherein the communicating M-plane data comprises communicating the M-plane data with a distributed unit (DU) over an M-plane segment, and initiating communication of the M-plane data at a second port of the RU, the second port configured for data communication over an alternate M-plane segment to a second RU of the set of RUs for forwarding the M-plane data to the DU over a second M-plane segment between the second RU and the DU, wherein the initiating communication is in response to an interruption in the communicating M-plane data.

One or more aspects of the subject disclosure include receiving configuration information for a radio unit (RU) of a plurality of radio units (RUs) arranged for cellular communications at a base station of a cellular network, and communicating management plane (M-plane) data on a first port of the RU, the M-plane data related to management and control of the RU; wherein the communicating the M-plane data is responsive to the configuration information, wherein the communicating the M-plane data comprises exchanging data with a distributed unit (DU) over an M-plane segment, wherein the DU is associated with the cellular network. Aspects of the subject disclosure further include receiving updated configuration information related to an interruption in communication between a second RU of the plurality of RUs and the DU, configuring a second port of the RU for communication of M-plane data with the second RU, receiving rerouted M-plane data detected at the second port of the RU on an alternate M-plane segment between the RU and the second RU, and communicating the rerouted M-plane data between the second port of the RU and the first port of the RU for communication over the M-plane segment with the DU.

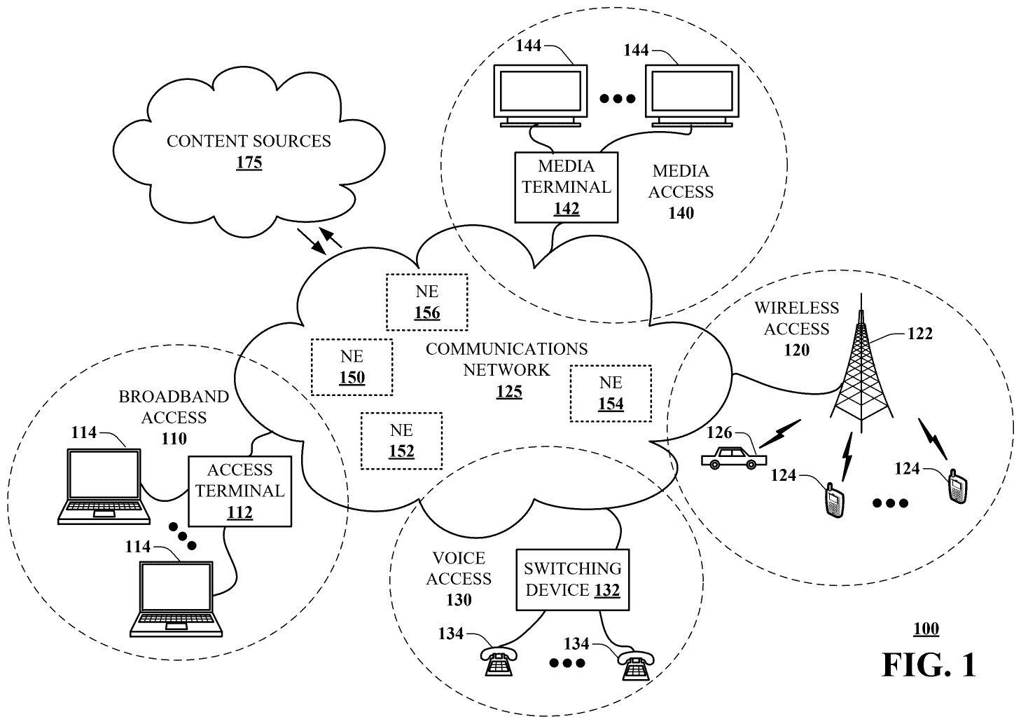

Referring now to FIG. 1, a block diagram is shown illustrating an example, non-limiting embodiment of a system 100 in accordance with various aspects described herein. For example, system 100 can facilitate in whole or in part communicating M-plane data at a first port of a radio unit in an O-RAN with a distributed unit in the O-RAN and, in response to an M-plane communication failure, rerouting communication of the M-plane data to a second port of the radio unit and thence to a second radio unit of the O-RAN so that the second radio unit may forward the M-plane data to the distributed unit, maintaining M-plane communication. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

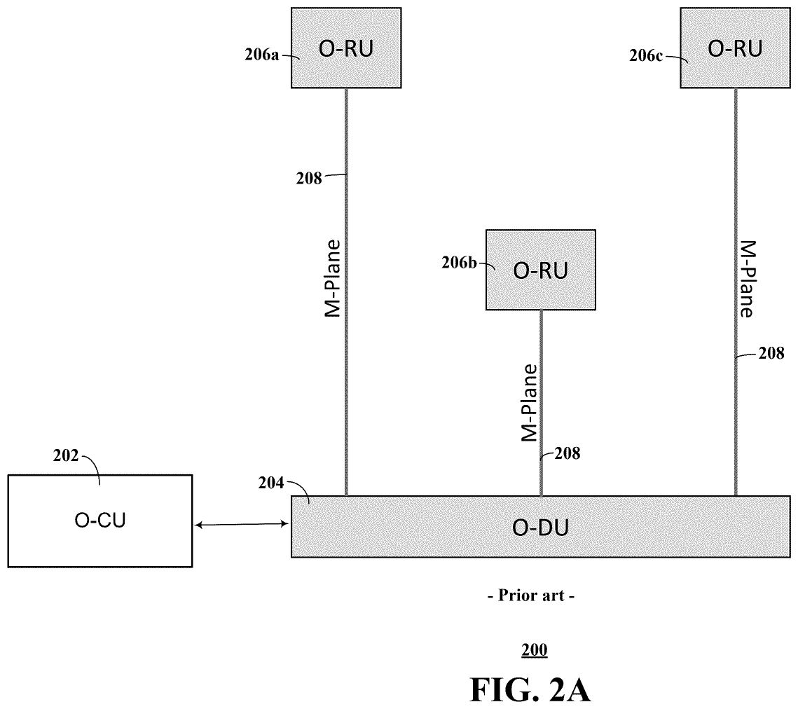

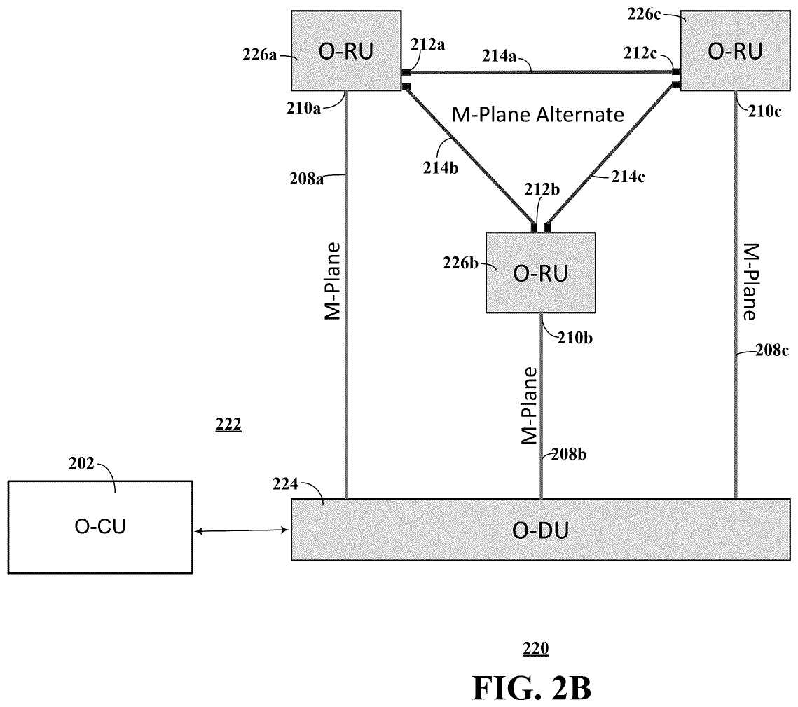

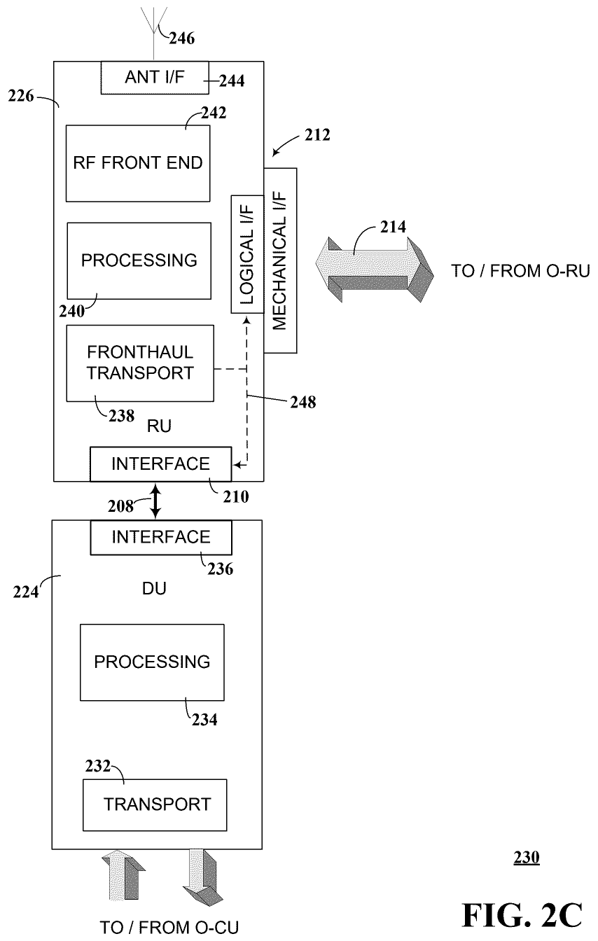

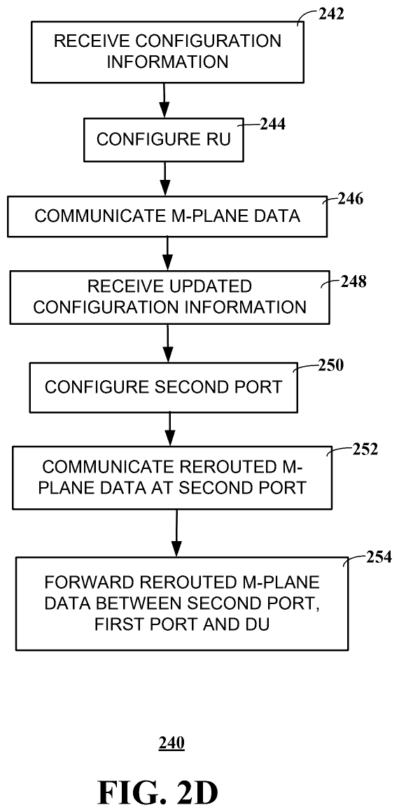

FIG. 2A is a block diagram illustrating a conventional Open Radio Access Network (O-RAN) instance 200. O-RAN is an approach to designing and deploying cellular network infrastructure. O-RAN enables use of modular functional components for performing cellular network functions. The components are manufacturer-agnostic enabling mixing of different components in a common system and simplifying design, installation and maintenance of the infrastructure. The O-RAN instance 200 may be associated with or be a part of a cellular network such as wireless access 120 in FIG. 1.

The O-RAN instance 200 includes a centralized unit (CU) 202, a distributed unit (DU) 204 and a plurality of radio units (RU) including RU 206a, RU 206b, and RU 206c. In general, the CU 202 handles higher-layer functions such as radio resource management (RRM), mobility management (MM) and radio access network (RAN) control. The CU 202 may be deployed in some instances in a centralized data center or a cloud environment operated by a network operator.

The CU 202 is in data communication with the DU 204. Communication may be over fiber networks, dedicated cables or otherwise. Further, communication may be according to any suitable standard such as the Ethernet standard. Ethernet® is a registered trademark of Xerox Corp. The DU 204 performs baseband processing of radio signals for transmission and reception at a cell site of the cellular network. Baseband processing includes functions such as signal modulation and demodulation and channel coding. The DU 204 can be located at the cell site or at a centralized location.

The DU 204 is in data communication with one or more RUs such as RU 206a, RU 206b, and RU 206c. The radio units connect to one or more antennas and form the physical layer of the cellular network. The RUs are generally located at the base station or cell site of the cellular network. By means of an antenna, the RUs transmit and receive radio signals to user equipment (UE) in a service area of the base station. Each RU communicates digital data with the DU 204 and converts between the digital data and radio frequency (RF) signals for radio transmission. In a conventional deployment, the three RUs including RU 206a, RU 206b, and RU 206c are deployed on or near a cell tower. The cell tower includes three corresponding antennas that each provide 120 degrees of azimuth coverage around the cell tower.

As indicated in FIG. 2A, the DU 204 communicates with the RUs over a maintenance plane or M-plane 208. Further, not shown in the drawing figure, the DU 204 and the RUs communicate over a control user and synchronization (CUS) plane. The CUS plane in O-RAN includes a control plane for control functions of the network such as signaling, authentication and resource management. The CUS plane further includes a user plane for data plane functions of the network such as user data and a synchronization plane for synchronization of timing between network components.

The M-plane in O-RAN radio units includes an interface for management and control functions. Such management and control may be provided for the network by a Service Management and Organization (SMO) function, not shown in FIG. 2A. The SMO is a centralized platform for the network operator to configure, monitor, and optimize O-RAN components and services. The SMO may use a framework called FCPS, for fault management, configuration management, accounting management, performance management and security management. Fault management enables identifying and resolving issues such as hardware failures in the O-RAN, such as indicated by an alarm coming from the radio at the RU to the SMO. Configuration management enables configuring of O-RAN components like the RU and DU 204. Accounting management enables collecting data on network usage to support billing. Performance management relates to monitoring key performance indicators (KPI's) of the O-RAN ran network such as signal quality, latency, and throughput. Security management relates to implementing security measures to protect the O-RAN network from threats like unauthorized access and data breaches. FCAPS information is conveyed over the M-plane. Further, the M-plane also conveys software handling and management (SHM) information for managing the software components of the DU 204 and RUs. This may include life cycle management for the RU such as updating software components to the latest versions, including patches and bug fixes. Communications on the M-plane are predefined according to a published standard.

The M-plane provides a standardized way for an operator of the network including the O-RAN instance 200 to manage and monitor the RUs to enable efficient operation and troubleshooting. Connections over the M-plane 208 allow remote configuration of parameters of an RU including, for example, frequency bands, power levels and antenna settings. Further, such connections over the M-plane 208 allow real-time monitoring of performance metrics of the RU including, for example, signal quality, power consumption and temperature. Further, such connections over the M-plane 208 enable detection, isolation and correction of faults within the RU.

RUs such as RU 206a, RU 206b, and RU 206c are in data communication with the DU 204. The physical connection between an RU and the DU 204 is generally an optical fiber for high data rate and minimal interference. The M-plane 208 can use various interfaces for data communication with the DU 204. These interfaces include an O-RAN Management Plane (OMP) which is a standardized interface defined for managing and controlling O-RAN components. Such M-plane interfaces can also include RESTful APIs, which is a web-based interfaces that allows for flexible and scalable management. Such M-plane interfaces may further include simple network management protocol (SNMP) for network management. Further, the DU 204 and RUs such as RU 206a, RU 206b, and RU 206c may communicate using Enhanced Common Public Radio Interface (eCPRI). The eCPRI interface is a standardized interface for O-RAN which supports secure, efficient, scalable communication between an RU and the DU. Data over this connection may be termed fronthaul data and includes control information and customer data for radio communication with a UE or other device.

As noted, the physical connection between an RU and the DU 204 is generally an optical fiber. Other physical connectors may be used. In a conventional implementation, the RUs are located high atop a cellular tower adjacent the antennas. One or more optical fibers carry optical signals between the tower top and the location of the DU. The optical signals include both control signals and customer data.

It may happen that there is a loss of connectivity between the DU 204 and an RU through the fiber or at another point on the physical path between the two components. In such a case, the failure may go undetected for a time because of the loss of connectivity. Further, the affected RU may still be fully functional, but just disconnected from the DU by the failure in the communications path. Identification and troubleshooting of the fault may be costly and time consuming. For example, when the network operator becomes aware of the fault at a radio unit, the network operator may need to send a service crew and equipment to the cell site. The crew arrives with little more information than that there is a non-functioning sector at the cell. The crew may need to climb the tower and test various components to isolate and repair the fault. Repair may be as simple as a repaired connection or break in a fiber. However, this can take time to regain observability of the RU over the M-plane. All these steps and processes can reduce the desired reliable, efficient operation of the network. In conventional systems, there is no alternative path for M-plane communications in O-RAN implementations.

FIG. 2B is a block diagram illustrating an example, non-limiting embodiment of a system 220 functioning within the communications network 125 of FIG. 1 in accordance with various aspects described herein. The system 220 includes an O-RAN instance 222. The O-RAN instance 222 may be associated with or be a part of a cellular network such as wireless access 120 in FIG. 1.

System and method in accordance with various aspects described herein may address the risk of a failure in M-plane communications. Some embodiments provide for implementation of a dedicated failover mechanism for the M-plane (Management Plane) in O-RU (Open Radio Unit) as part of the O-RAN (Open Radio Access Network) architecture. In embodiments, this includes establishing a secondary physical interface and protocol specifically for maintaining M-plane operations in the event of a failure.

In some embodiments, a new physical port on each O-RU may be added for failover purposes. Failover in a communication network is a mechanism that allows a system to automatically switch to a backup or redundant component in case of a failure. This ensures uninterrupted service and minimizes downtime. This new or additional port can use different types of media such as copper, fiber, or wireless connections. The interface may support both logical and physical dimension association, meaning the interface may recognize and manage both the data link and the physical aspects of the connection.

A specific protocol may be defined to manage the interconnection between O-RUs. This protocol may ensure seamless failover and is robust, secure, and scalable to maintain M-Plane functions. The protocol aligns with O-RAN principles of openness and interoperability, allowing different vendors'equipment to interconnect without issues.

In cases where a physical connector is used to couple RUs for the failover interface, may be an industry-standard connector to ensure compatibility and ease of integration. The connection may support both the logical (e.g., data, signaling) and physical dimensions (e.g., wiring, ports), ensuring that the failover mechanism operates reliably in both aspects.

The interface, protocol, and hardware for the failover mechanism may be open and defined within the O-RAN standards, ensuring that different vendors can implement and support this feature without proprietary restrictions.

To ensure resilience of the M-plane in the face of failures, each O-RU may include a dedicated physical port. This port is designed specifically to handle M-plane failover functions, enabling continued management operations when the primary M-plane interface fails. The choice of interface—whether copper, fiber, wireless, or other—will depend on the specific deployment scenario and operational requirements.

Different port types may be selected based on design requirements and other factors. Examples are provided below.

Copper (Ethernet): Copper Ethernet connections, typically using RJ45 connectors, offer a cost-effective and widely used solution for the dedicated failover port. Ethernet ports are ubiquitous in network equipment, providing a familiar and straightforward option for implementing the failover mechanism. Copper connections are particularly advantageous in short-range applications. They provide sufficient bandwidth for M-plane traffic, and their reliability is well established in various networking environments.

Fiber Optic: Fiber optic connections offer a high-bandwidth, low-latency alternative to copper. Fiber optics are especially suitable for longer distances or environments where electromagnetic interference (EMI) is a concern. In situations where O-RUs are distributed over a large area—such as across rooftops of a building, fiber optics can provide the necessary performance and reliability.

Wireless Interfaces: Wireless technologies, such as Wi-Fi, Zigbee or Bluetooth, may also be considered for the failover interface. Wireless connections offer flexibility in situations where running physical cables is impractical. Wireless solutions can also be deployed quickly, offering a versatile option for tower tops.

The failover interface generally manages both logical and physical dimensions of the connection, ensuring that management functions can continue seamlessly even in the event of a physical link failure. This dual capability may be important in maintaining a resilient and reliable M-plane. Logical dimension management involves ensuring that data packets, signaling, and control messages are correctly routed and delivered across the failover interface. This includes maintaining synchronization with other O-RUs and ensuring that any changes in the network topology are quickly recognized and adapted to. On the physical dimension side, the interface may ensure that the physical layer is robust, capable of handling the expected data load, and resilient to environmental factors such as interference, physical damage, or degradation over time.

In practice, this may mean that the failover interface may be equipped with capabilities such as automatic link negotiation, error detection, and correction mechanisms, and the ability to monitor and adjust for physical layer conditions. For example, in a fiber optic connection, the interface should be able to detect and compensate for signal attenuation or dispersion, ensuring that the M-plane traffic is not disrupted by physical layer issues. In a wireless setup, the interface may need to adapt to changing environmental conditions, such as varying signal strength or interference, to maintain a stable connection.

An inter-RU protocol may be established for control and management of data communications. The inter-O-RU protocol operates to ensure that O-RUs can maintain M-plane functionality when the primary link fails. This protocol is designed to meet the specific needs of O-RAN networks, which include interoperability, reliability, security, and scalability.

The protocol may be defined to manage communication between O-RUs over the dedicated failover port, ensuring that the M-plane can be maintained regardless of the specific deployment scenario. The protocol should also be capable of dynamic reconfiguration, allowing it to adapt to changes in the network. Should be independent of specification changes.

One important aspect of the protocol design is its ability to detect and respond to M-plane failures quickly. In embodiments, this includes built-in mechanisms for fault detection, such as heartbeat messages or link status monitoring, which can immediately trigger failover procedures if a problem is detected. The protocol may include mechanisms for load balancing across remaining O-RU, ensuring that the M-plane traffic is evenly distributed across available links, reducing the likelihood of congestion or overload during failover operations.

Reliability and Redundancy: Use of the protocol helps to ensure reliable communication between O-RUs, even in cases of network failure or degradation. This includes the ability to automatically detect and recover from failures, as well as the capability to maintain multiple redundant paths for M-Plane traffic. For example, if a fiber optic link fails, the protocol may automatically switch to a wireless backup link without disrupting ongoing management operations.

Low Latency: Quick detection and response to M-plane failures are critical to maintaining network stability. The protocol supports quick change to ensure that failover occurs within milliseconds, minimizing the impact on network operations. In embodiments, this involves techniques such as preemptive failover, where the protocol anticipates potential failures and prepares backup paths in advance, reducing the time required to switch over when a failure occurs.

Security: Given that the M-plane handles critical management and control functions, the protocol may include robust security features. These should include encryption to protect M-plane traffic from interception. The protocol should also support secure key management and distribution mechanisms, ensuring that encryption keys are rotated regularly and securely exchanged between O-RUs if applicable.

Openness and Interoperability: The protocol aligns with O-RAN principles of openness and interoperability, ensuring that it can be implemented across different vendors'equipment. This includes adherence to industry standards and participation in the O-RAN Alliance's standardization efforts, ensuring that the protocol is compatible with a wide range of hardware and software platforms. Interoperability testing should be a key part of the protocol's development and deployment, ensuring that it can seamlessly operate in multi-vendor environments.

The choice of connectors for the dedicated failover port is important to ensuring compatibility, ease of integration, and reliability. For example, industry-standard connectors may be used to ensure that the failover mechanism can be implemented across different vendors'equipment without requiring custom solutions or proprietary technologies.

Referring again to FIG. 2B, similar to the O-RAN instance 200 of FIG. 2A, the O-RAN instance 222 of system 220 includes a centralized unit (CU) 202, a distributed unit (DU) 224 and a plurality of radio units (RU) including RU 226a, RU 226b, and RU 226c. In general, the CU 202 handles higher-layer functions such as radio resource management (RRM), mobility management (MM) and radio access network (RAN) control.

Similar to the O-RAN instance 200, the O-RAN instance 202 is in data communication with the DU 224. Communication may be over fiber networks, dedicated cables or otherwise, in the conventional manner. Further, communication may be adapted and supplemented to provide certain M-plane control functions and capabilities in accordance with aspects described herein. The DU 224 performs baseband processing of radio signals for transmission and reception at a cell site of the cellular network.

The DU 224 is in data communication with one or more RUs such as RU 226a, RU 226b, and RU 226c. The RUs are generally located at the base station or cell site of the cellular network. In a typical implementation, the RUs are located at the top of a cell tower, adjacent to one or more antennas that provide 360 degrees coverage of a service area. Each respective RU and a respective antenna or antenna portion provides coverage to 120 degrees of azimuth. While three RUs are shown in the example of FIG. 2B, any number of radios may be provided and served by the DU 224. For example, if a base station is associated with multiple frequency bands, individual radios or RUs may be assigned to each respective frequency band, for each sector. The alternate M-plane connections represented in FIG. 2B may be extended to any number of RUs in a single installation or embodiment. Any convenient or desired configuration of RUs and alternate M-plane segments may be selected, such as a ring connection or a star connection among alternate M-plane segments. The triangle connection illustrated in FIG. 2B is intended to be exemplary only.

As indicated in FIG. 2B, and similar to the conventional manner, the DU 224 communicates with the RUs over a maintenance plane or M-plane 208. In FIG. 2B, the M-plane is illustrated as respective M-plane segments enabling communication between the DU and a respective RU. The M-plane segments thus include M-plane segment 208a, M-plane segment 208b and M-plane segment 208C. Further, not shown in the drawing figure, the DU 224 and the RUs communicate over a control, user and synchronization (CUS) plane. Other communication planes and resources may be established as well, to supplement or replace aspects of the M-plane or the CUS plane.

Each respective RU among the RUs, including RU 226a, RU 226b, and RU 226c in this example, includes a first port for physical and electrical connection to its respective M-plane segment. Thus, in the example, RU 226a includes a first port 210a which couples to and communicates with the M-plane segment 208a and, thereby, with the DU 224. Further, RU 226b includes a first port 210b which couples to and communicates with the M-plane segment 208b and, thereby, with the DU 224. Still further, RU 226c includes a first port 210c which couples to and communicates with the M-plane segment 208c and, thereby, with the DU 224.

The respective first ports including first port 210a, first port 210b and first port 210c are coupled with respective ports of the DU 224. The DU 224 includes complementary ports for mechanically and electrically coupling with the respective RUs. Data and other information may be conveyed on the M-plane segments and the CUS plane and other communication resources are conveyed over any suitable physical medium. In many applications, fiber optic cable provides the best solution for reasons of mechanical integrity and data integrity.

In the example embodiment, the first ports of the RU 226a, RU 226b, and RU 226c include Small Form Pluggable ports. Small Form Pluggable (SFP) ports are a type of modular optical interface commonly used in networking equipment. SFPs provide a compact and interchangeable way to connect optical fibers to devices such as switches, routers, and transceivers, as well as the respective RUs and the DU 224. SFP modules provide many benefits. First, SFP modules are significantly smaller than some optical interfaces, allowing for denser port connections in networking equipment. Second, SFP modules can be inserted or removed while the equipment is powered on, providing flexibility and reducing equipment downtime. Third, SFP modules are available in a variety of types with different specifications and are readily interchangeable. Fourth, SFP modules adhere to standardized specifications ensuring interoperability.

Thus, the RUs are readily connected to an M-plane segment to the DU 224 by plugging an optical cable into the SFP module. The RU further includes a network interface card (NIC) or other components for optical to electrical conversion for the receiver and electrical to optical conversion for the transmitter. Disconnection is equally simple. These mechanical, optical and electrical features make the SFP modules excellent for ease of installation and troubleshooting of equipment.

In accordance with various aspects described herein, each respective RU 226, including RU 226a, RU 226b, and RU 226c, includes a second port 212 for physical and electrical connection to an alternate M-plane segment 214. In the example of FIG. 2B, RU 226a includes a second port 212b which couples to and communicates with alternate M-plane segment 214a and, thereby, with a second port 212c of RU 226c. Further, second port 212a of RU 226a couples to and communicates with alternate M-plane segment 214b and, thereby, with a second port 212b of RU 226b. Further, RU 226b includes the second port 212b which also couples to and communicates with alternate M-plane segment 214c and, thereby, with the RU 226c. RU 226c includes a second port 212c which couples to and communicates with the alternate M-plane segment 214c and, thereby, with the RU 226b.

In a first embodiment, the second port of each RU includes a SFP module similar to the SFP module used to couple the first port of the RU with the DU 224. As noted, SFP modules are well known, readily available and standardized to enable fast assembly, troubleshooting and replacement. If an RU such as RU 226a is contained in a cabinet mounted on a cell tower, for example, the SFP for the first port 210a and the SFP for the second port 212a may be positioned in any suitable location, such as side by side, for easy access by service personnel.

In a second embodiment, the second port of each RU includes a physical interface which is different from the SFP module used for the first port. Any suitable electrical or optical interface may be selected and used for connecting among the RUs.

Examples include Ethernet connections, universal serial bus (USB), and others. They physical interface may comprise a standard connector that mechanically engages and locks with a fitting or receptacle mounted on a house of the RU, for example. Factors in selection for a particular connection include required bandwidth, required latency, cost, reliability and security. In a typical application, three RUs such as RU 226a, RU 226b, and RU 226c are mounted atop a cell tower and thus located just a few meters apart. The length of each alternate M-plane segment is relatively insignificant.

In a third embodiment, a remote electrical tilt port may be used to mechanically and electrically couple an alternate M-plane segment with an RU. A remote electrical tilt port is a specialized port located on a cell site tower RU or antenna that allows for the remote adjustment of the antenna's electrical tilt without requiring physical access to the antenna itself. Electrical tilt refers to the angle at which the antenna's radiation pattern is oriented. In accordance with the third embodiment, the remote electrical tilt port may be modified or adapted to form the second port and thereby to accommodate alternate M-plane communications at the RU.

In a fourth embodiment, the second port of the RU includes a wireless transceiver for data communication of M-plane data on the alternate M-plane segment. Any suitable wireless transceiver may be used, including for example, Wi-Fi according to any of the IEEE 802.11xx standards published by the Institute of Electrical and Electronics Engineers, Bluetooth (Bluetooth is a standardized through the Bluetooth Special Interest Group which has registered the trademark), Zigbee (Zigbee is a registered trademark of the Connectivity Standards Alliance) or IEEE 802.15.4 published by IEEE, or any other suitable short range wireless connection. The wireless connection should support data rates on the order of hundreds of megabits per second, over a distance of several meters. Other noted desirable features, such as low latency and security, should be met as well. Since Wi-Fi transceiver devices are generally inexpensive, physically small and rugged and require low operating power, a Wi-Fi interface with one or more Wi-Fi transceivers at each second port of the RU may be an adequate solution to provide alternate M-plane communication.

In embodiments, the second ports, including second port 212a, second port 212b and second port 212c, are physically and functionally identical to the first ports including first port 210a, first port 210b, and first port 210c. As noted, the first port and the second port may be formed using similar or identical SFP modules which can interchangeably receive a suitable optical cable. In other embodiments, one port such as the first port is designated as the primary port for M-plane connectivity and the second port is designated for alternate M-plane connectivity. For reliable data communication, respective ports may be assigned a port address or network address or other unique identifier or combination of identifiers. The first port and the second port may share a common port address or may otherwise provide for conflict avoidance in data communication.

The alternate M-plane paths provided by the alternate M-plane segments among the respective RUs may be used for data communication with the RU 226 when the primary M-plane connection is inoperable. In the example, M-plane segment 208c becomes inoperable. The inoperability may be due to a failure such as a cut or broken optical fiber or connection, a failed module such as an SFP module, or any other reason. The inoperability may be one aspect of a failover condition. Failover in a communication network is a mechanism that allows a system to automatically switch to a backup or redundant component in case of a failure.

The network, such as the CU 202 or another network component, determines that communication with the RU 226c is down. For example, each RU may transmit a predefined heartbeat signal to indicate its presence and status. Absence of the heartbeat signal at the receiver may indicate an inoperable connection. In another example, transmissions to the RU 226c are not being acknowledged. No data is received from the RU 226c. Or, in another example, the communication with the RU 226c over the M-plane segment 208c becomes unreliable. For example, a bit error rate (BER) increases and exceeds a predetermined threshold, such as a BER of 10⁻⁶. If the BER or another data loss rate exceeds a threshold, the network may conclude that the primary M-plane connection to the RU 226c is inoperable.

Upon a conclusion that the primary M-plane connection to the RU 226c is inoperable, the network may instead establish a connection to route data between the DU 224 and the RU 226 over primary M-plane segment 208b and alternate M-plane segment 214c. The connection is bidirectional data so that the network can continue receiving fault, performance and other data, and so that the network can continue providing control and management data. For example, full FCAPS capacity may be maintained.

In this example, control data intended for the RU 226c may be addressed to the DU 224. From the DU 224, the control data may be communicated over the primary M-plane segment 208b to first port 210b of the RU 226b. The RU 226b includes operational features to forward the data from the first port 210b to the second port 212b and to the alternate M-plane segment 214c. The control data is then conveyed to the second port 212c of the RU 226c. Data in the reverse direction, such as fault reporting data, may follow the same path back to the DU 224.

Similarly, another path may be selected by the network based on current usage or other requirements. In this example, the primary M-plane segment 208b is inoperable. The RU 226b, with performance or fault data to report, detects the inoperability and selects second port 212b and alternate M-plane segment 214b for routing the data to second port 212a of the RU 226a. The RU 226a internally conveys the data from the second port 212a to the first port 210a and then to the primary M-plane segment 208a. Other possible configurations may be extended from these examples.

In some embodiments, the second port 212 may be used for troubleshooting a failed M-plane connection. For example, in some embodiments, each RU including RU 226a, RU 226b and RU 226c, receives commands including control instructions from a remote source such as CU 202. The CU 202 may instruct each respective RU to test connections on the primary M-plane segment 208 and on the alternate M-plane segment 214. In response, each respective RU may initiate a handshaking procedure or other data exchange to confirm that each primary M-plane segment and each alternate M-plane segment is intact and functioning. If a segment is non-functional, the RUs on each end of the segment will identify that condition and report accordingly. The CU or other system may deduce the location of the failure based on feedback from the individual RUs.

FIG. 2C is a block diagram illustrating an example, non-limiting embodiment of a system 230 functioning within the communications network 125 of FIG. 1 in accordance with various aspects described herein. The system 230 includes a DU 224 and an RU 226. Each component, the DU 224 and the RU 226, generally operates in accordance with conventional devices in an O-RAN network, as modified and adapted as described herein. The DU 224 and the RU 226 are described functionally at a high level.

The exemplary DU 224 includes a transport circuit 232, a processing system 234 including one or more processors and memory and an interface 236. The transport circuit 232 operates to communicate with remote network equipment such as a centralized unit (CU) in an O-RAN network. The transport circuit 232 may include an optical to electrical interface, modulators and demodulators, error checking functions and other modules to ensure fast, reliable communication for the DU 224. The processing system 234 may include any suitable processing capabilities to control operation of the DU 224, including hardware and software.

The interface 236 is configured for mechanical and electrical or optical engagement with a segment of the M-plane 208 such as M-plane segment 208a in FIG. 2B. In a typical embodiment, the interface 236 includes an SFP module for an SFP port. The SFP module is generally configured to receive a plug-in connector for an optical connection. The interface 236 further includes optical to electrical conversion for data to be communicated over the M-plane segment to the RU 226.

The RU 226 includes a first interface 210, a second interface 212, a fronthaul transport module 238, a processing system 240, a radio frequency (RF) front end 242, an antenna interface 244 for connection to an antenna 246, and a selectable data path 248. The embodiment of FIG. 2C is intended to be exemplary only. Other embodiments will include additional or alternative elements and functions.

The first interface 210 generally mirrors the interface 236 of the DU 224. The first interface 210 is configured for mechanical and electrical or optical engagement with an M-plane segment such as M-plane segment 208a in FIG. 2B. In a typical embodiment, the first interface 210 includes an SFP module for an SFP port. A suitable plug-in connector may be connected to the first interface 210 to establish M-plane communication for the RU 226 with the DU 224. The first interface 210 of the RU 226 and the interface 236 of the DU 224 in typical embodiments communicate using a standard such as Enhanced Common Public Radio Interface (eCPRI) or Fronthaul Interface (FHI).

The fronthaul transport module 238 connects through the first interface 210 to the DU 224 for transmitting and receiving data including user data. Fronthaul data may include user information for radio communication and control information. The processing system 240 may include any suitable processing capabilities to control operation of the RU 226, including hardware and software. The RF front end 242 includes circuitry and modules adapted for communicating digital data with other components of the RU 226 and RF signals with the antenna interface 244. For example, the RF front end 242 may include a low noise amplifier module, a power amplifier module, modulators, demodulators, and other components as well. Amplified radio signals for transmission are supplied to the antenna interface 244 for transmission through the antenna 246. Similarly, radio signals detected by the antenna 246 are passed to the antenna interface 244 for reception at the RF front end 242.

The second interface 212 of the RU 226 is configured for wireline or wireless communication with another RU, not shown in FIG. 2C. The second interface 212 may function generally as described in connection with FIG. 2B. The second interface 212 may communicate with another RU on an alternate M-plane segment 214 when the primary M-plane 208 is inoperable. Communications may be routed between the first interface 210 and the second interface 212 in any suitable manner, under control of any device on the network. In the example, the RU 226 includes the selectable data path 248. In response to path selection commands, data for communication by the fronthaul transport module 238 including M-plane data may be selectively routed to either the first interface 210 or the second interface 212. Both the first interface 210 and the second module 212 may be used for data communication in some instances and in some embodiments.

In embodiments, path selection commands may be received from any suitable source. For example, a centralized unit (CU) such as the CU 202 of FIG. 2B, may provide commands over a suitable control interface to control routing of M-plane data in the RU 226. The commands including the path selection commands from the CU or other source may cause the RU to select operation and configuration of the selectable data path 248. For example, a first command may cause the RU to route M-plane data between the antenna interface 244 and the first interface 210 in the conventional manner. In response to a failure in the M-plane segment 208, the CU or other source may issue a command to instead route M-plane data between the antenna interface 244 and the second port 212. The second port 212 may further be commanded to configure for data communication with another RU, such as by initiating a wireline link with suitable handshake and synchronization signals with the other RU, or by initiating a wireless link with the other RU by activating or otherwise accessing a wireless network. The commands may be received, for example, over the CUS plane. Commands may be communicated in accordance with any suitable command and control protocol.

In an exemplary application, the second interface 212 is configured for mechanical and electrical or optical engagement with an alternate M-plane segment 214 such as alternate M-plane segment 214a in FIG. 2B. In a typical embodiment, the second interface 212 includes an SFP module for an SFP port. A suitable plug-in connector, forming a mechanical interface, may be connected to the second interface 212 to establish M-plane communication for the RU 226 with the alternate M-plane segment and another RU. The second interface 212 of the RU 226 in typical embodiments includes a logical interface which communicates using a standard such as Enhanced Common Public Radio Interface (eCPRI) or Fronthaul Interface (FHI).

In some embodiments, the second interface 212 includes a wireless interface for communication on the alternate M-plane with another RU. One suitable example of a wireless interface includes a Wi-Fi transceiver operating according to IEEE 802.11xx standards. Any suitable controls signals or networking messages may be communicated to the second interface 212 to enable the Wi-Fi transceiver and initiate a wireless local area network (WLAN), for example. The WLAN may be instantiated on the fly, under network control or under control of the processing system 240 or the RU 226, for example. Or, in some embodiments, the WLAN may be set up at the time of installation of the RU 226 with other radios or RUs at a cell site. Each respective RU may have a network address on the WLAN. Upon detection of a failed M-plane connection to the DU, the WLAN may be used to reroute M-plane data from an RU on the WLAN to another RU on the WLAN, forming a wireless alternate M-plane segment. A selectable data path such as selectable data path 248 of the RU 226 may be configured to communicate M-plane data between the wireless alternate M-plane segment and the second interface 212 to the first interface 210 and thereby on to the segment of the M-plane 208 and the DU. Any other wireless radio capability may be used in place of or in addition to Wi-Fi.

FIG. 2D depicts an illustrative embodiment of a method 240 in accordance with various aspects described herein. The method 240 may be performed, for example, at an RU such as RU 226 of FIG. 2C. The RU is one of a set of RUs associated with an O-RAN. For example, the O-RAN may include a plurality of RUs mounted together atop a cellular base station with an antenna of the base station. The RUs operate according to standardized procedures for an O-RAN, including communicating with a distributed unit (DU) and a centralized unit (CU) which may be located remotely. The RUs communicate a variety of data with the DU including management plane (M-plane) data. The M-plane data enables management and control of features and operation of the RU. The method 240 may be initiated, for example, when the RU begins operating or is reset to a known start condition.

At step 242, the RU receives configuration information. In embodiments, this includes receiving configuration to control various interfaces and ports of the RU for data communication with other devices. For example, the RU may include a first interface for two-way data communication with the DU. Such communication may be over the M-plane and may be over an optical fiber for example. The optical fiber or other data connection linking the RU and the DU may be termed an M-plane segment. Communication of M-plane information between the RU and DU is standardized according to published standards for ORA networks. Configuration information for the first port may specify information such as network addresses, port addresses, communication parameters, and other information to enable reliable M-plane data communication. At step 244, the RU configures itself according to the received configuration information.

At step 246, the RU communicates M-plane information with the DU. For example, the RU may report performance data such as traffic statistics for the RU and quality of service (QoS) metrics. The RU may report alerts and alarms related to potential problems. The RU may report error logs and fault history, for example. The RU may receive configuration data such as parameters for radio communication, network topology information and access control information. In general, the M-plane information is communicated with the DU directly over an M-plane segment. The M-plane segment may be one or more network connections such as fiber optic cables extending between the RU and the DU.

At step 248, the RU receives updated configuration data. In embodiments, the updated configuration data is generated and received by the RU based on an M-plane communication failure. For example, the DU may detect that no communication has been received on the M-plane from the RU over a predetermined amount of time, such as 10 seconds. This apparent silence may be due to a structural failure or a functional failure such as a failed optical cable between the DU and the RU. In more extreme cases, the silence may be due to a failed RU. The DU cannot know the source of the silence without more information. Be reconfiguring the RU, or aspects of the RU, the DU or the CU operating through the DU may be able to get more information.

In embodiments, then the updated configuration information includes configuration information for the second port of the RU. The second port is configured for data communication with a similar second port of at least one other RU of the set of RUs associated with a O-RAN, such as a tower-top set of RUs at a cell site. In embodiments, the first port of each RU is designated for connection with the DU for M-plane communication. Further, the second port of each RU is designated for connection with other RUs of the set of RUs for backup or rerouted data communication in a failover situation. Thus, if one or more RUs loses communication on the M-plane with the DU, the two-way M-plane data for that RU may be rerouted over alternate M-plane segments to one or more other RUs of the set of RUs. The connection or connections between second ports of the RUs serve to communicate rerouted M-plane data of an RU experiencing an M-plane communication failure.

The updated configuration data may include any suitable information. For example, in some embodiments, the second port of the RU includes a Small Form Pluggable (SFP) port configured to receive a plug-in optical cable. The other end of the optical cable may extend to another RU of the set of RUs and plug in to the second port of the other RU. The updated configuration information may include information to activate the SFP port and to route data internally between the first port, coupled to the DU, and the second port coupled to the RU. M-plane data of the RU will then be rerouted to the second port of the RU, over the optical cable to the other RU and then on to the DU. Multiple hops across multiple RUs of the set of RUs may be required. Updated configuration information may be sent to each RU in the chain to reconfigure the RUs along the way.

In some embodiments the updated configuration information may be communicated to the remote electrical tilt port of the base station. The remote electrical tilt port is generally configured to receive information such as a target tilt angle and a tilt direction. This information is typically communicated between a network management system and a base station controller of the base station. A similar data path may be adapted to convey configuration information to the RU and to communicate M-plane data with the RU.

In some embodiments, the second port of the RU is associated with or includes a wireless transceiver. Other RUs of the set of RUs also include complementary wireless transceivers so that the RUs may communicate wirelessly. Such communication may include signals corresponding to M-plane data including rerouted M-plane data. For example, the RU may include a Wi-Fi transceiver that may attach to a Wi-Fi network using conventional techniques according to, for example, the IEEE 802.11xx standards. The Wi-Fi or other wireless network may form an alternate M-plane segment between two or more RUs. The Wi-Fi network may be set up temporarily while needed for rerouting M-plane data from an RU experiencing a failing M-plane connection to the DU. In other embodiments, a low-power, short-range permanent wireless local area network (WLAN) may be set up at the tower-top for communication of information including rerouted M-plane data among the RUs. The WLAN may be controlled by a local device such as one of the RUs or a dedicated component. Or, the WLAN may be controlled remotely by other network equipment such as the CU. At step 250, the second port of the RU is configured according to the updated configuration information.

At step 252, with the second port reconfigured, the RU communicates rerouted M-plane data at the second port. Depending on the physical layer and resources selected, the second port may receive re-routed M-plane data over an optical cable at an SFP module for example, or other hardware device. In other examples, the rerouted M-plane data may be received wirelessly from another RU.

At step 254, the rerouted M-plane data is forwarded within the RU between the second port and the first port. The first port is in reliable data communication over an M-plane segment with the DU, thus enabling delivery of the rerouted M-plane data to the DU.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

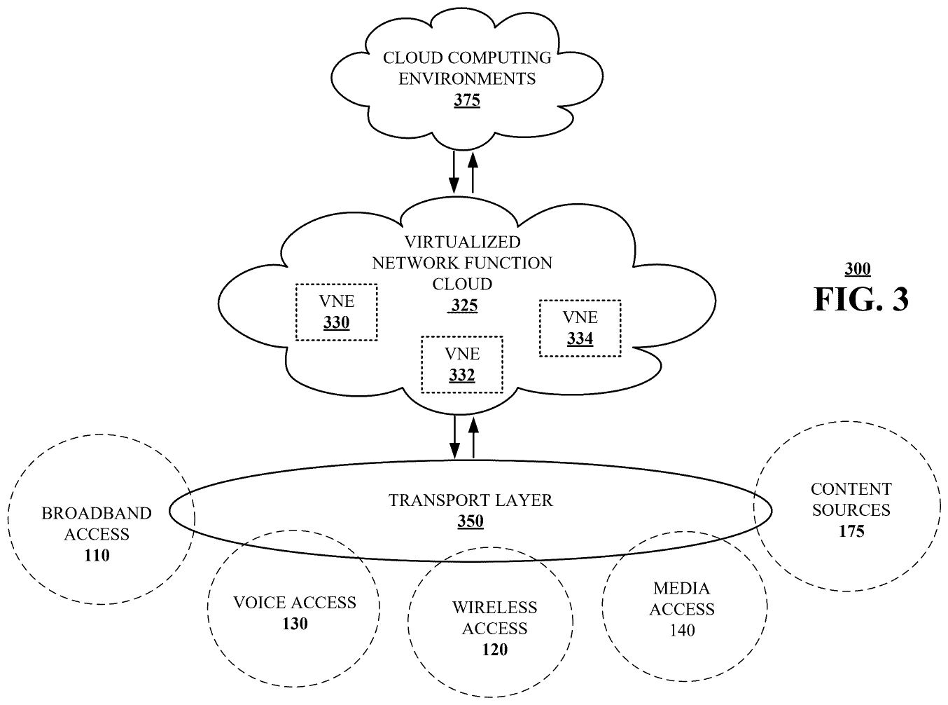

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 220 and method 240 presented in FIG. 1, FIG. 2A, FIG. 2B, FIG. 2C, FIG. 2D and FIG. 3. For example, virtualized communication network 300 can facilitate in whole or in part communicating M-plane data at a first port of a radio unit in an O-RAN with a distributed unit in the O-RAN and, in response to an M-plane communication failure, rerouting communication of the M-plane data to a second port of the radio unit and thence to a second radio unit of the O-RAN so that the second radio unit may forward the M-plane data to the distributed unit, maintaining M-plane communication.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

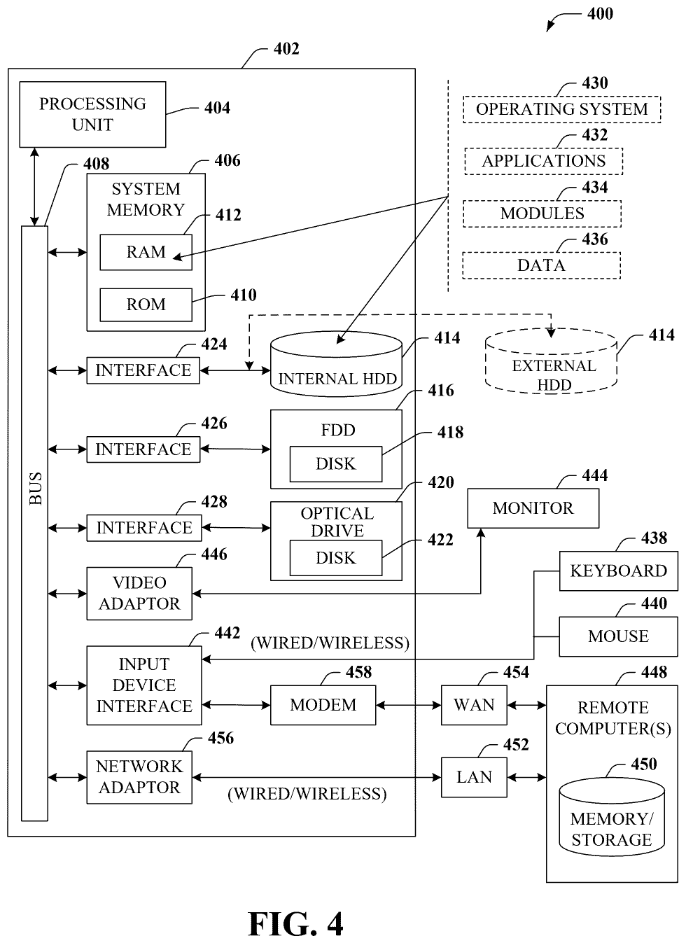

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part communicating M-plane data at a first port of a radio unit in an O-RAN with a distributed unit in the O-RAN and, in response to an M-plane communication failure, rerouting communication of the M-plane data to a second port of the radio unit and thence to a second radio unit of the O-RAN so that the second radio unit may forward the M-plane data to the distributed unit, maintaining M-plane communication.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

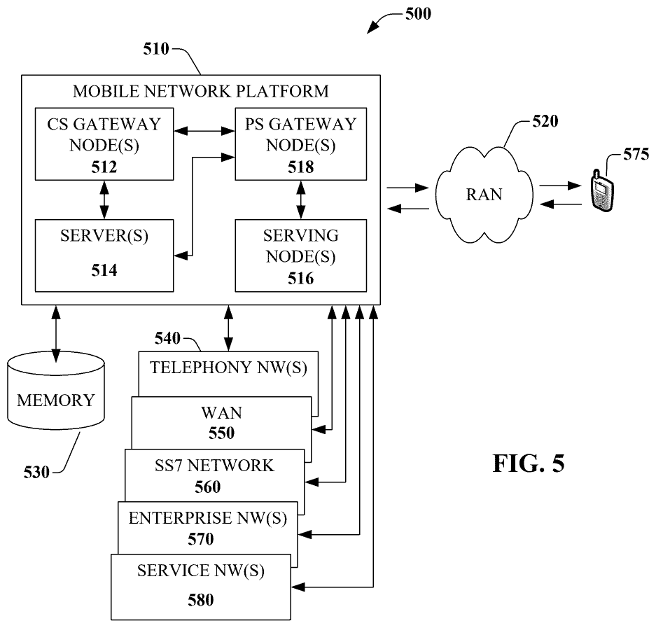

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part communicating M-plane data at a first port of a radio unit in an O-RAN with a distributed unit in the O-RAN and, in response to an M-plane communication failure, rerouting communication of the M-plane data to a second port of the radio unit and thence to a second radio unit of the O-RAN so that the second radio unit may forward the M-plane data to the distributed unit, maintaining M-plane communication. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

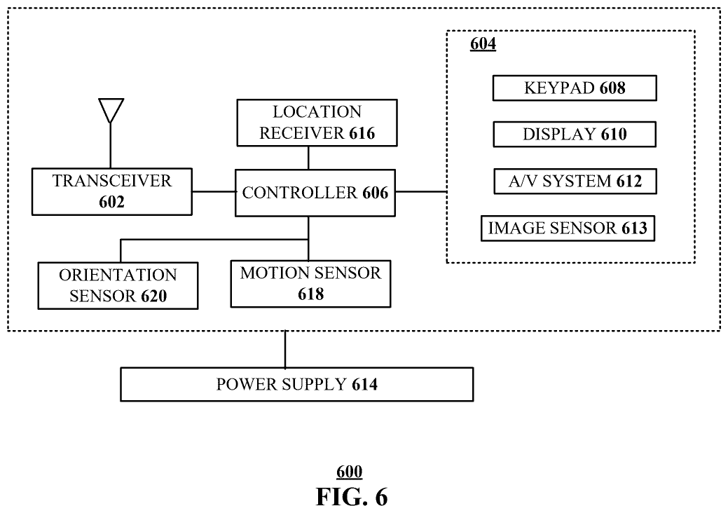

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part communicating M-plane data at a first port of a radio unit in an O-RAN with a distributed unit in the O-RAN and, in response to an M-plane communication failure, rerouting communication of the M-plane data to a second port of the radio unit and thence to a second radio unit of the O-RAN so that the second radio unit may forward the M-plane data to the distributed unit, maintaining M-plane communication.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure.

The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. An Open Radio Access Network (O-RAN) Radio Unit (RU), comprising:
a first port configured for data communication;
a second port configured for data communication with another O-RAN RU operating in an O-RAN;
a processing system including a processor; and
a memory that stores executable instructions that, when executed by the processing system, facilitate performance of operations, the operations comprising:
communicating management plane (M-plane) data on the first port over an M-plane segment with a distributed unit (DU) operating in the O-RAN;
detecting a failover condition of the M-plane segment; and
automatically selecting the second port for communication of the M-plane data with the DU, wherein the automatically selecting the second port is responsive to the detecting the failover condition of the M-plane segment.

2. The O-RAN RU of claim 1, wherein the first port comprises a Small Form Pluggable module configured for coupling with an optical cable.

3. The O-RAN RU of claim 2, wherein the second port comprises a Small Form Pluggable module configured for coupling with a first end of second optical cable for communication of the M-plane data with the DU, a second end of the second optical cable couplable to the other O-RAN RU to form an alternate M-plane segment for communication of the M-plane data.

4. The O-RAN RU of claim 1, wherein the automatically selecting the second port for communication of the M-plane data with the DU comprises:
communicating the M-plane data with the other O-RAN RU over the second port for forwarding of the M-plane data, by the other O-RAN RU, to the DU over a second M-plane segment coupling the other O-RAN RU with the DU.

5. The O-RAN RU of claim 1, wherein the operations further comprise:
receiving, from the other O-RAN RU, at the second port, failover M-plane data, the failover M-plane data communicated to the O-RAN RU from the other OR-AN RU in response to a failover condition of a second M-plane segment coupling the other O-RAN RU with the DU; and
forwarding the failover M-plane data to the DU on the first port over the M-plane segment with the DU.

6. The O-RAN RU of claim 1, wherein the second port comprises a wireless transceiver configured for wireless data communication with a remote wireless transceiver of the other O-RAN RU, wherein a wireless connection between the wireless transceiver and the remote wireless transceiver forms an alternate M-plane segment for communication of the M-plane data.

7. The O-RAN RU of claim 1, wherein the operations further comprise:
receiving a command to reroute the M-plane data from the first port and the M-plane segment to the second port and the other O-RAN RU for forwarding by the other O-RAN RU to the DU.

8. The O-RAN RU of claim 7, wherein the second port comprises a wireless transceiver configured for wireless data communication with a remote wireless transceiver of the other O-RAN RU, wherein a wireless connection between the wireless transceiver and the remote wireless transceiver forms an alternate M-plane segment for communication of the M-plane data, and wherein the operations further comprise:
receiving a command to initiate the wireless connection between the wireless transceiver and the remote wireless transceiver.

9. The O-RAN RU of claim 1, wherein the second port comprises:
a remote electrical tilt port associated with the O-RAN RU.

10. The O-RAN RU of claim 1, wherein the operations further comprise:
receiving a command to troubleshoot the failover condition; and
exchanging signals with other O-RAN RU devices of the O-RAN, including the other O-RAN RU, to isolate the failover condition in the O-RAN.

11. A non-transitory machine-readable medium, comprising executable instructions that, when executed by a processing system including a processor, facilitate performance of operations, the operations comprising:
communicating management plane (M-plane) data at a first port of a radio unit (RU), the RU being one RU of a set of radio units (RUs) at a cell site of a network operator, the M-plane data related to management and control of the RU, wherein the communicating M-plane data comprises communicating the M-plane data with a distributed unit (DU) over an M-plane segment; and
initiating communication of the M-plane data at a second port of the RU, the second port configured for data communication over an alternate M-plane segment to a second RU of the set of RUs for forwarding the M-plane data to the DU over a second M-plane segment between the second RU and the DU, wherein the initiating communication is in response to an interruption in the communicating M-plane data.

12. The non-transitory machine-readable medium of claim 11, wherein the initiating communication of the M-plane data at the second port of the RU comprises:
communicating the M-plane data at a wireless transceiver associated with the second port, the wireless transceiver configured for wireless communication with a second wireless receiver associated with a second port of the second RU.

13. The non-transitory machine-readable medium of claim 11, wherein the operations further comprise:
receiving, from the second RU, at the second port of the RU, failover M-plane data, the failover M-plane data communicated to the RU from the second RU in response to an interruption condition of a second M-plane segment designated for data communication between the second RU and the DU; and
forwarding the failover M-plane data from the RU to the DU over the first port to the M-plane segment to the DU.

14. The non-transitory machine-readable medium of claim 13, wherein the operations further comprise:
receiving, from a remote controller, a command to initiate communication between the second port of the RU and a second port of the second RU.

15. The non-transitory machine-readable medium of claim 11, wherein the initiating communication of the M-plane data at the second port of the RU comprise:
negotiating, with the second RU, a communication link between the second port of the RU and a second port of the second RU, including negotiating an error correction and detection scheme.

16. A method, comprising:
receiving, by a processing system including a processor, configuration information for a radio unit (RU) of a plurality of radio units (RUs) arranged for cellular communications at a base station of a cellular network;
communicating, by the processing system, management plane (M-plane) data on a first port of the RU, the M-plane data related to management and control of the RU; wherein the communicating the M-plane data is responsive to the configuration information, wherein the communicating the M-plane data comprises exchanging data with a distributed unit (DU) over an M-plane segment, wherein the DU is associated with the cellular network;
receiving, by the processing system, updated configuration information related to an interruption in communication between a second RU of the plurality of RUs and the DU;
configuring, by the processing system, a second port of the RU for communication of M-plane data with the second RU;
receiving, by the processing system, rerouted M-plane data detected at the second port of the RU on an alternate M-plane segment between the RU and the second RU; and
communicating, by the processing system, the rerouted M-plane data between the second port of the RU and the first port of the RU for communication over the M-plane segment with the DU.

17. The method of claim 16, wherein the configuring the second port of the RU comprises:
initiating, by the processing system, a wireless transceiver configured for wireless communication of the rerouted M-plane data with a second wireless transceiver associated with the RU.

18. The method of claim 17, wherein the receiving updated configuration information comprises:
receiving, by the processing system, information identifying the second RU among the plurality of RUs for communicating the rerouted M-plane data; and
initiating, by the processing system, wireless communication with the second RU including identifying a network address for the second RU and initiating data exchange with the second RU.

19. The method of claim 18, further comprising:
identifying, by the processing system, the second RU on a wireless local area network including the plurality of RUs, wherein the identifying is based on the network address for the second RU.

20. The method of claim 16, wherein the configuring the second port of the RU comprises:
configuring, by the processing system, a Small Form Pluggable (SFP) module adapted for logical connection and physical connection with an optical cable in communication with the second RU; and
communicating, by the processing system, the rerouted M-plane data between the optical cable and the SFP module at the second port of the RU to the first port of the RU for communication over the M-plane segment with the DU.
